(19) United States
(12) Patent Application Publication
(10) Pub. No.: US 2022/0212091 A1
(43) Pub. Date: Jul. 7, 2022

(54) PHONETIC GAME SYSTEM

(71) Applicants: Austin Leong, San Jose, CA (US); Timothy Lee, San Jose, CA (US)

(72) Inventors: Austin Leong, San Jose, CA (US); Timothy Lee, San Jose, CA (US)

(21) Appl. No.: 17/569,190

(22) Filed: Jan. 5, 2022

Related U.S. Application Data
(60) Provisional application No. 63/134,460, filed on Jan. 6, 2021.

(51) Int. Cl. A63F 1/04; B43L 1/00; B43K 29/02

(52) U.S. Cl. CPC A63F 1/04; A63F 2001/0458; B43K 29/02; B43L 1/00

(57) ABSTRACT

A phonetic game system and method of operation can include: providing a card having a word thereon; and providing a marker for a player to write a misspelled version of the word and for marking the misspelled version of the word with an indication of a point based on the misspelled version of the word having a sound phonetically correct to an other player.

### TECHNICAL FIELD

The field of the invention is with respect to games. In particular, the field of invention deals with a word game involving phonetic pronunciation of intentionally misspelled words.

### BACKGROUND

Numerous innovations for games exist. However, no previous innovations currently exist that encourage players to intentionally misspell words to obtain points to win a game.

### SUMMARY

The subject matter of this disclosure is directed toward a phonetic game that relies on intentionally misspelled words that sound phonetically correct to the players in the phonetic game. In one embodiment, a first active player selects a vocabulary card from a list of vocabulary cards, and intentionally misspells the word on the vocabulary card as many times as possible within a minute (or a set time limit).

In another contemplated embodiment, the other players can determine if any of the misspell words sound phonetically correct. In yet another contemplated embodiment, the other players can agree which misspell words sound phonetically correct, and which misspelled words are not phonetically correct.

In yet another contemplated embodiment, the player is awarded points based on the misspelled words that were determined to sound phonetically correct. In yet another contemplated embodiment, the other players can take a turn with a vocabulary card from the deck of vocabulary cards. In yet another contemplated embodiment, the amount of points of each player is used to determine a winner of the phonetic game. The player with the most points is the winner of the phonetic game.

Many alterations and modifications may be made by those having ordinary skill in the art without departing from the spirit and scope of the subject matter of this disclosure. Therefore, it must be understood that any illustrated or preferred embodiments discussed in this application have been set forth only for the purposes of example, and that it should not be taken as limiting the subject matter of the disclosed invention. Thus, preferred or illustrative embodiments of a phonetic game on intentional misspelled words with correct pronunciations have been disclosed. It should be apparent, however, to those skilled in the art that many more modifications besides those already described are possible without departing from the inventive concepts herein.

While aspects of the present invention have been described with reference to at least one exemplary embodiment, it is to be clearly understood by those skilled in the art that the invention is not limited thereto.

### BRIEF DESCRIPTION OF THE DRAWINGS

The invention is illustrated in the figures of the accompanying drawings which are meant to be exemplary and not limiting, and in which:

FIG. 1 is an isometric view of the phonetic game system in a first embodiment.

FIG. 2 is a flowchart for playing the phonetic game system of FIG. 1.

FIG. 3 is an isometric view of the phonetic game system in a second embodiment.

FIG. 4 is a flowchart for playing the phonetic game system of FIG. 3.

FIG. 5 is an isometric view of a misspelling step of the phonetic game system of FIG. 3.

FIG. 6 is an isometric view of a voting step of the phonetic game system of FIG. 1 or of FIG. 3.

FIG. 7 is an isometric view of a grading step for the phonetic game system in a third embodiment.

FIG. 8 is a flowchart for playing the phonetic game of FIG. 7.

### DETAILED DESCRIPTION

In the following description, reference is made to the accompanying drawings that form a part hereof, and in which are shown by way of illustration, embodiments in which the invention may be practiced. It is to be understood that other embodiments may be utilized and structural changes may be made without departing from the scope of the inventive subject matter. For the purposes of this disclosure, players and participants are intended to have the same meaning.

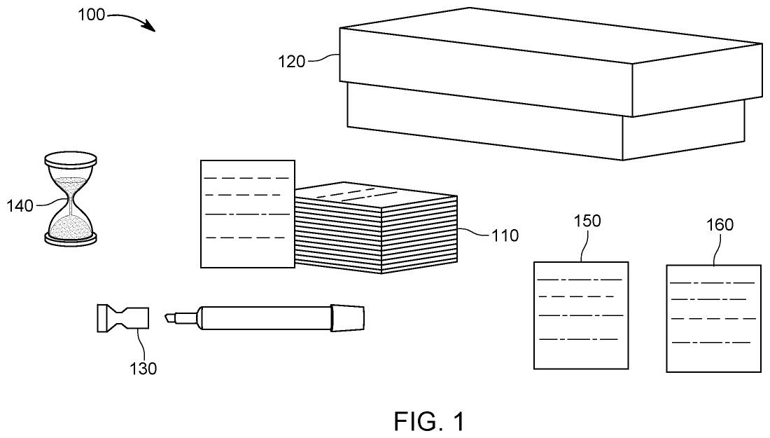

In particular, FIG. 1 depicts a preferred embodiment of a phonetic game system 100. The phonetic game system 100 can include cards 110, wherein the cards 110 can have dry erase material coating. One or more words can be written on each of the cards 110. The cards 110 can be placed within or next two a two-piece box 120.

The two-piece box 120 can be used to store the cards 110. The two-piece box 120 can also be placed apart from the cards 110 as well. A dry erase marker/eraser 130 can also be part of the phonetic game system 100. The dry erase marker/eraser 130 can be used to erase words off each of the cards 110. Further, the dray erase marker/eraser 130 can also be used to scratch out words and place new words on the cards 110 as well.

In FIG. 1, the phonetic game system 100 can also include a timer 140. The timer 140 can provide a time duration and be used by each player to time themselves while it is their turn during the course of the phonetic game. In an embodiment, the players can each set the timer 140 to one minute for their respective turn, before the next participate in the phonetic game begins his/her turn.

The phonetic game system 100 can also include instructions 150. The players can decide the instructions 150 for the phonetic game which each player in the phonetic game will adhere to. Further, the phonetic game system 100 can also include misspelled instructions 160 as well.

As the phonetic game relates to intentionally misspelling words, the players can include misspelled instructions 160. The misspelled instructions 160 can provide the players with further instructions in relation to the players intentionally spelling words during the course of the phonetic game.

In FIG. 1, the contents of the phonetic game system 100 described above enable the players of the phonetic game system 100 to play multiple rounds and iterations of the phonetic game. Further, in other embodiments, the players can adjust the instructions 150 and the misspelled instructions 160 to aid in their enjoyment of the phonetic game.

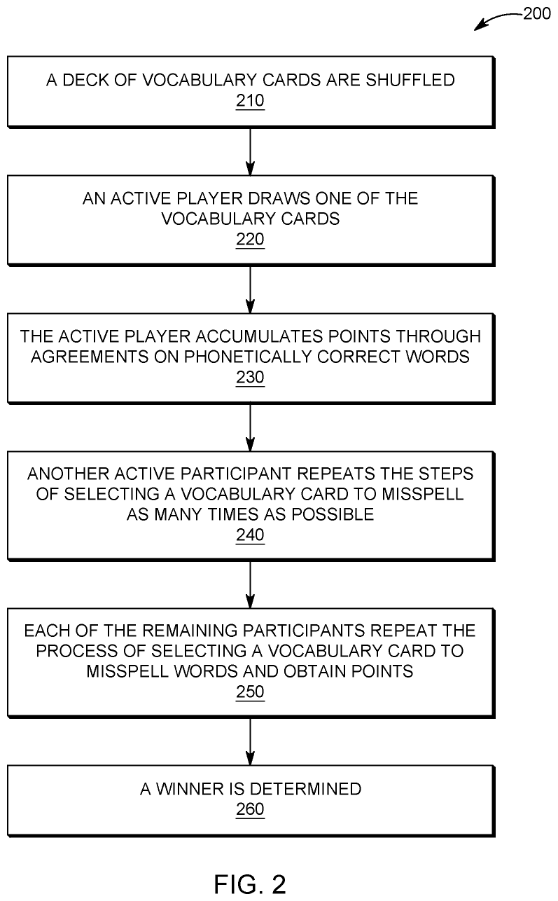

In FIG. 2, a method 200 for playing the phonetic game system 100 of FIG. 1 is illustrated. The phonetic game can have four or more players playing. Each playing will have a turn at the phonetic game in a counter-clockwise direction. The first active player of the phonetic game can be selected by the first active player that says the word “what?” or if one of the players is randomly picked to start.

In FIG. 2, at step 210, a vocabulary grade level deck of cards is shuffled. The cards are shuffled to increase the spontaneity to the game. The player choosing the card should be able to choose a card at random. The card which the player chooses should not be predetermined.

Referring to FIG. 2, at step 220, the active player will draw one of the vocabulary cards from the shuffled deck. Once the active player has drawn the vocabulary card, he/she will write as many misspelled versions of the presented vocabulary word as initially seen on the card.

The active player will intentionally misspell the vocabulary word in a way where the misspelled still sounds phonetically correct to the active player and to the other players. The active player will misspell the vocabulary word as many times as possible within a one-minute time limit set by the timer. After the time is up, the active player may select another card from the deck, or another player can take a turn and pick one of the vocabulary cards from the shuffled deck.

In FIG. 2, at step 230, the active player will accumulate points. The accumulated points are achieved through a majority vote of all the players. The active player will present all his/her misspelled words to the inactive players.

The inactive players will determine which of the incorrectly spelled words sound phonetically correct to the presented vocabulary word on the card that the active player chose. For every majority vote in agreement of the misspelled words, the active player will receive one point.

Moreover, for every majority vote in disagreement of each misspelled words, the active player will receive zero points. Each point can be marked with a check mark as an indication of the point based on the misspelled version of the word having a sound phonetically correct.

Further, if there is a tie in votes in agreement and votes in disagreement for a misspelled word, then the active player will receive zero points for the disputed misspelled word. After the voting is completed, the active player will add up his/her current points.

With respect to FIG. 2, at step 240, the next player's turn takes player, wherein the next player picks a vocabulary card within the shuffled deck. The next player will repeat the steps described above with respect to the previous active player.

In FIG. 2, at step 250, each of the remaining players then choose a vocabulary card, and repeat the steps for the previous active players, and accumulate any points for misspelled words which has a majority vote in agreement that the misspelled words sound phonetically correct to the non-active players. Each round is completed after the final player has completed his/her turn.

Referring to FIG. 2, at step 260, the total points for each player is noted, and the winner is awarded based on which player has the most points. The phonetic game can be played from anywhere from 1-3 rounds or more.

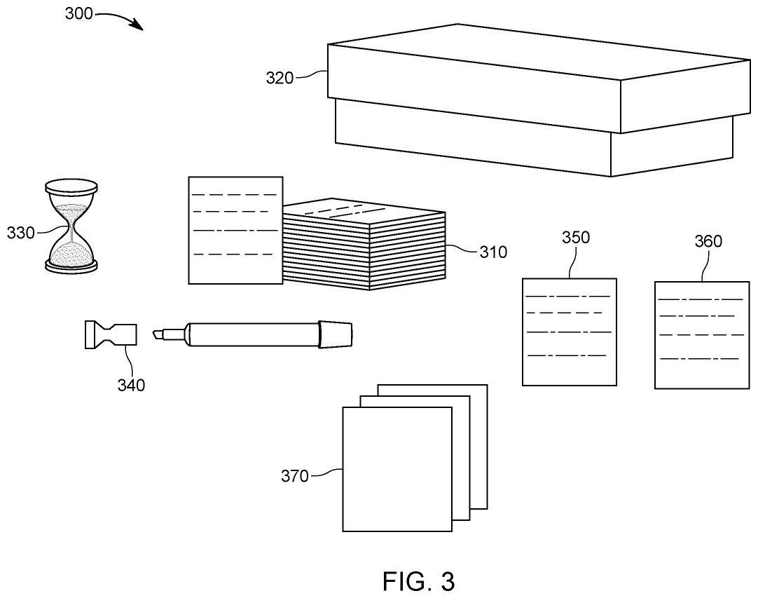

FIG. 3 illustrates a phonetic game system 300 for impatient people. The phonetic game system 300 can include vocabulary cards 310 which each have one or more words. A two-piece box set 320 is also illustrated. In addition, a timer 330 is illustrated. The timer 330 can provide a time duration.

The players can be given a time limit for each turn using the timer 330. A dry erase marker/eraser 340 is also illustrated that each player can use to erase one or more misspelled words when required. Also included are instructions 350 and misspelled instructions 360. In addition, the phonetic game system 300 also includes a writing board 370.

The writing board 370 can be larger than the vocabulary cards 310, can allow the misspelled words to be erased with the dry erase marker/eraser 340, and can be a paper board, a white board, or other board with a dry erase material coating.

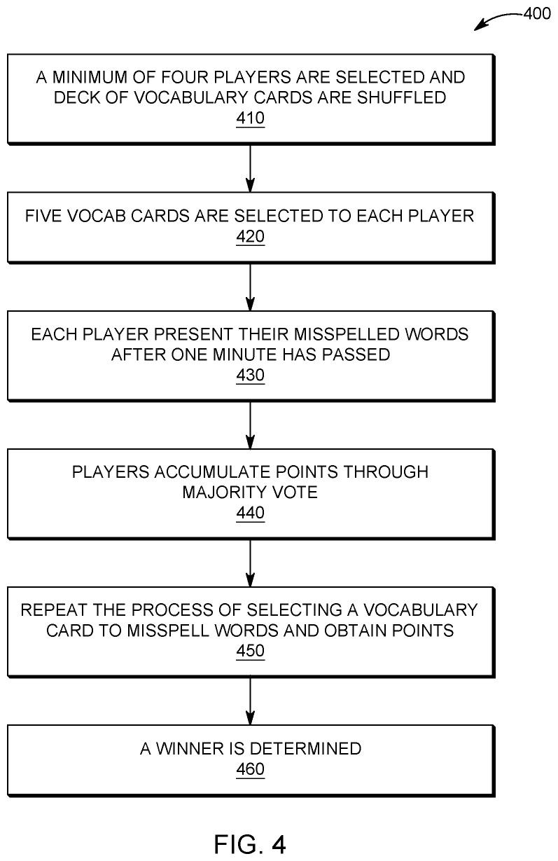

FIG. 4 illustrates a method 400 for playing the phonetic game system 300 of FIG. 3 with rules for impatient people. The players of the phonetic game can be impatient, and rules of the phonetic game can be designed specifically for impatient people as a result. The game can have a minimum of four players. The first player is selected by whoever says “what?” first. A first player can also be randomly selected.

In FIG. 4, at step 410, a minimum of four players are selected. The first active player is selected by whoever says “what” first, or by random selection. The vocabulary grade level deck is grabbed and shuffled.

In FIG. 4 at step 420, five of the vocabulary cards are selected, in which all the players are presented with the five vocabulary cards. Each of the players must misspell the presented five words with as many misspelled versions as possible. Each player will have one minute to misspell the presented vocabulary words.

With respect to FIG. 4 at step 430, the players present all their misspelled words after one minute has passed.

In FIG. 4, at step 440, the players will accumulate their points accordingly through a majority vote. Each player presents their misspelled words to the non-presenting players.

The non-presenting players will determine which of the misspelled words sound phonetically identical or phonetically correct to the initial vocabulary words seen on the vocabulary cards. For every majority vote in agreement of each misspelled word, the presenting player will receive a point.

Moreover, for every majority vote in disagreement of a misspelled word, the presenting player will receive zero points. Each point can be marked with a check mark as an indication of the point based on the misspelled version of the word having a sound phonetically correct.

Once the non-presenting players have finished voting, the presenting player will add up his/her point total. The person left of the presenting player, is the next player to reveal his/her misspelled words for majority voting.

In FIG. 4, at step 450, the remaining players present and accumulate their points.

In FIG. 4, at step 460, a winner is determined by the player with the most points.

Accordingly, it is intended to embrace all such alternatives, modifications, and variations, which fall within the scope of the included claims. All matters set forth herein or shown in the accompanying drawings are to be interpreted in an illustrative and non-limiting sense.

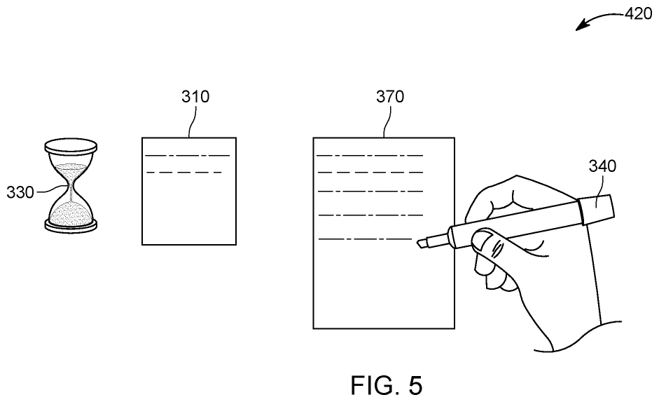

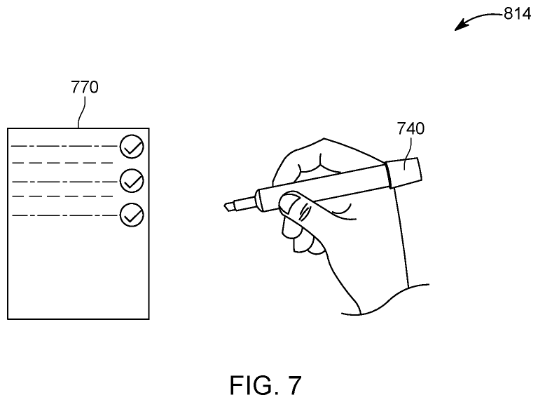

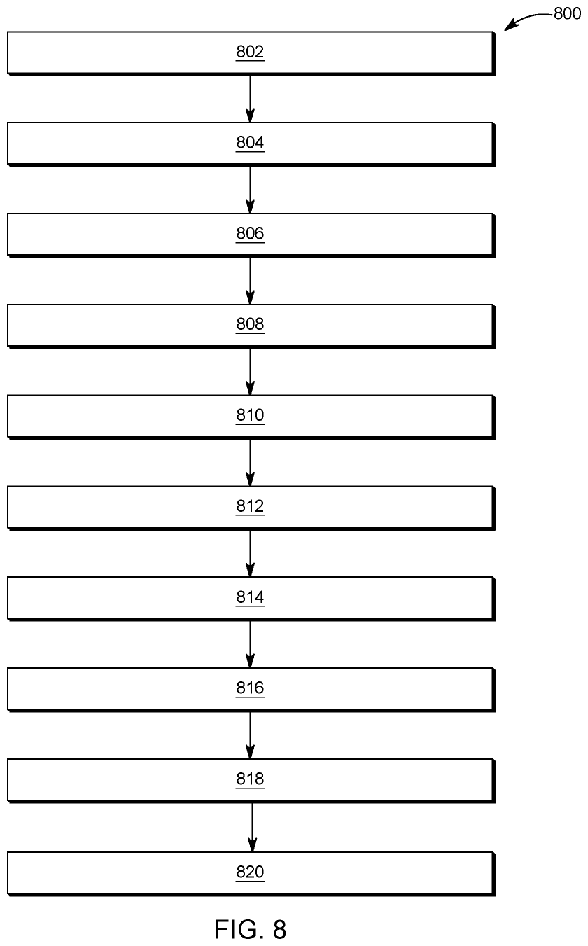

In FIG. 5, an isometric view of a misspelling step of the phonetic game system 300 of FIG. 3 is shown. The misspelling step can for example be step 420 and is shown with the timer 330 being in use while an active player writes misspelled versions of a vocabulary word. It is contemplated that the misspelling step could also be the write step 812 of FIG. 8 for the phonetic game system 700 of FIG. 7.

The vocabulary word can be contained on the vocabulary cards 310. The active player can write the misspelled versions of the vocabulary word on the writing board 370. The writing board 370 can be larger than the vocabulary cards 310, can allow the misspelled words to be erased with the dry erase marker/eraser 340, and can be a white board or have a dry erase material coating.

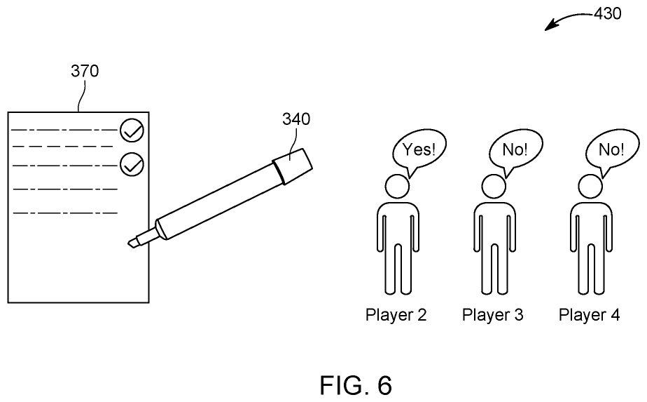

In FIG. 6, an isometric view of a voting step of the phonetic game system 100 of FIG. 1 or the phonetic game system 300 of FIG. 3 is depicted. Illustratively, the voting step could be described as the step 230 of FIG. 2 or the step 430 of FIG. 4.

For descriptive ease, the element numbers from the second embodiment of FIG. 3 are used. The misspelled words written on the writing board 370 are presented and voted on by each of the non-presenting players. A majority vote of whether the misspelled words sound phonetically correct or sound phonetically identical to the presented vocabulary word on the vocabulary card 310 of FIG. 3. The dry erase marker/eraser 340 is used to place a check mark next to each word with a majority vote and cross out words without a majority vote.

In FIG. 7, an isometric view of a grading step 814 of FIG. 8 for the phonetic game system 700 in a third embodiment is shown. A dry erase marker/eraser 740 is used to mark each of the misspelled words written on a writing board 770.

The writing board 770 can be larger than the vocabulary cards 310 of FIG. 3 for example, can allow the misspelled words to be erased with the dry erase marker/eraser 340, and can be a paper board, a white board, or other board with a dry erase material coating.

When it is time for the grading step 814, each player will pass their whole writing board 770, to another player in any order desired. Once all players have received someone else's writing board 770, they will use their judgment to determine what words have been misspelled but sound phonetically correct to the original spelling.

Players will place a check mark next to each word they agree with and cross out words they disagree with. The writing board 770 will then be returned to the original player. Once each writing board 770 has been returned to the original players, each check mark is added up and will be the sum of points accumulated for a round.

In FIG. 8, a flowchart for playing the phonetic game of FIG. 7 is shown. The flow chart can include a start step 802. The start step 802 can require a minimum of 4 players. In one contemplated version a max of 8 players can be used however, it is also contemplated that more players could be used.

In the start step 802 one player must grab the attention of the party and proceed to pretend to roll a dice. Once completed, ask “What number just hit?”, the first person to respond will now be the first active player. If the party appears uncooperative, just pick the person to the right to be the first active player.

The writing board 770 of FIG. 7 and the dry erase marker/eraser 740 of FIG. 7 can be distributed to each player in a writing utensil distribution step 804. The desired vocabulary grade level deck(s) can be obtained in a vocabulary deck selection step 806. The selected vocabulary deck can be shuffled in a shuffling step 808.

Once shuffled a card ready step 810 can be performed, during which, the active player will draw 5 cards and place them face down on a flat surface where all players can visibly see where the cards are. It is contemplated that the flat surface is a table in front of all the players. Once all players are ready, the active player will flip the cards over and reveal the words to misspell. The active player will also flip the 3 minute timer as well.

Once the words are revealed each player must now misspell each and/or any of the revealed words as much as possible and record their answers to their writing board 770 within the time limit during the write step 812. When the timer has run out, all players must immediately halt all writing on their writing board 770.

After the write step 812 is complete, peer-to-peer grading can be performed in a grading step 814. When it is time for peer-to-peer grading, each player will pass their whole writing board 770 to another player in any order desired.

Once all players have received someone else's writing board 770, they will use their judgment to determine what words have been misspelled but sound phonetically correct to the original spelling. Players will place a check mark next to each word they agree with and cross out words they disagree with. Return the writing board 770 to the original player once the grading step 814 is complete.

Once each whiteboard has been returned to the original players, the amount of check marks on each writing board 770 will be added up in a tally step 816. This will be the sum of points accumulated for each player. Each point can be marked with a check mark as an indication of the point based on the misspelled version of the word having a sound phonetically correct.

The 5 previous cards played can be discarded and the person to the right of the previous active player is determined to be the new active player. Then repeat the card ready step 810, the write step 812, the grading step 814, and the tally step 816 for another round in a repeat step 818. The winner can be determined by tallying all the points for each player from all rounds in a determine winning player step 820.

What is claimed is:

1. A phonetic game system comprising:
a card having a word thereon; and
a marker for a player to write a misspelled version of the word and for marking the misspelled version of the word with an indication of a point based on the misspelled version of the word having a sound phonetically correct to an other player.

2. The system of claim 1 wherein the marker is for marking the misspelled version of the word with the indication of the point based on the misspelled version of the word having the sound phonetically correct to a majority of players including the other player.

3. The system of claim 1 further comprising a writing board for writing the misspelled version of the word.

4. The system of claim 1 wherein the card is one of a plurality of cards in a vocabulary grade level deck.

5. The system of claim 1 wherein the marker is a dry erase marker with an eraser.

6. A phonetic game system comprising:
a card having a word thereon;
a timer providing a time duration; and
a marker for writing a misspelled version of the word within the time duration of the timer and for marking the misspelled version of the word with an indication of a point based on the misspelled version of the word having a sound phonetically correct to an other player.

7. The system of claim 6 wherein:
the card is one of a plurality of cards each with a unique word, and where each of a plurality of players receives one of the plurality of cards; and
the marker is one of a plurality of markers, and where each of the plurality of players receives one of the plurality of markers to write a unique misspelled version of the unique word within the time duration.

8. The system of claim 6 wherein the marker is for marking the misspelled version of the word with a check mark based on the misspelled version of the word having the sound phonetically correct to the other player.

9. The system of claim 6 wherein the card has a dry erase material coating.

10. The system of claim 6 further comprising a two piece box for containing the timer, the card, and the marker.

11. A method of operating a phonetic game system comprising:
providing a card having a word thereon; and
providing a marker for a player to write a misspelled version of the word and for marking the misspelled version of the word with an indication of a point based on the misspelled version of the word having a sound phonetically correct to an other player.

12. The method of claim 11 wherein providing the marker is for marking the misspelled version of the word with the indication of the point based on the misspelled version of the word having the sound phonetically correct to a majority of players including the other player.

13. The method of claim 11 further comprising writing the misspelled version of the word on a writing board.

14. The method of claim 11 wherein providing the card includes providing the card as one of a plurality of cards in a vocabulary grade level deck.

15. The method of claim 11 wherein providing the marker includes providing a dry erase marker with an eraser.

16. The method of claim 11 further comprising providing a timer, the timer providing a time duration.

17. The method of claim 16 wherein:
providing the card includes providing the card as one of a plurality of cards each with a unique word, and where each of a plurality of players receives one of the plurality of cards; and
providing the marker includes providing the marker as one of a plurality of markers, and where each of the plurality of players receives one of the plurality of markers to write a unique misspelled version of the unique word within the time duration.

18. The method of claim 16 wherein providing the marker includes providing the marker for marking the misspelled version of the word with a check mark based on the misspelled version of the word having the sound phonetically correct to the other player.

19. The method of claim 16 wherein providing the card includes providing the card having a dry erase material coating.

20. The method of claim 16 further comprising a two piece box for containing the timer, the card, and the marker.
